(19) United States
(12) Patent Application Publication
(10) Pub. No.: US 2015/0230290 A1
(43) Pub. Date: Aug. 13, 2015

(54) PORTABLE AUXILIARY HEATING DEVICE

(71) Applicant: T&B NANOELEC, Anyang-si (KR)

(72) Inventor: Ki Ju IM, Namyangju-si (KR)

(21) Appl. No.: 14/691,257

(22) Filed: Apr. 20, 2015

Related U.S. Application Data
(63) Continuation of application No. PCT/KR2013/008276, filed on Sep. 12, 2013.

(30) Foreign Application Priority Data
Oct. 18, 2012 (KR) 10-2012-0115992

(51) Int. Cl. H05B 3/34; H05B 3/12

(52) U.S. Cl. CPC H05B 3/34; H05B 3/12

(57) ABSTRACT

A portable auxiliary heating device according to the present invention comprises: a base substrate; electrodes formed on both end portions of a top surface of the base substrate; an external power connection part connected to electrode lines which are connected to the electrodes; a heating layer stacked on the base substrate and generating heat by external power applied through the electrodes; and an insulation layer stacked on the heating layer, wherein the heating layer is made from a metallic oxide material.

### CROSS REFERENCE TO RELATED APPLICATION

This application claims the priority of Korean Patent Application No. 10-2012-0115992, filed on Oct. 18, 2012 in the KIPO (Korean Intellectual Property Office). Further, this application is the Continuation Application of International Application No. PCT/KR2013/008276 filed Sep. 12, 2013, which designates the United States and was published in Korean.

### TECHNICAL FIELD

The present invention is related to a portable auxiliary heating device, and more particularly, a portable auxiliary heating device wherein a surface heater, excellent in heating rate and heat retention, can generate heat for long hours on a single charge, and the reliability and stability are excellent.

### BACKGROUND ART

In general, a portable auxiliary heating device is made on the purpose of providing effects in maintaining body temperature or applying hot pack for heath. Such devices are useful in long-hour outdoor activities during the change of seasons or in the cold weather.

Korean Patent Laid-Open Publication No. 10-2011-0000031 (Prior art No. 1) discloses a portable heating device wherein a small water tank is formed, and the rest of the parts, except the heating part at the bottom, are in a state of vacuum to improve heat retention, achieving thermal effect by using small energy.

However, the heat source of the heating device according to Prior art No. 1 is acquired by hydration reaction of the quicklime. Using a small-packed quicklime as a heating element results in low heat efficiency and insufficient thermal effect because the maximum heating temperature is as low as 60° C., and the temperature dwelling time is too short. Maintaining the heat of reaction at 60° C. for long hours requires a large water tank and a plenty of quicklime, incurring increase of cost and decrease in economic feasibility.

Korean Patent Laid-Open Publication No. 10-2006-0037609 (Prior art No. 2) discloses a body warming device providing effects on body warming and applying hot pack at the same time by including a surface heater, in the form of a sheet in a certain size, providing heat on a part of the body; a case providing the heat, generated from the surface heater, to the body by holding an attachable surface heater in the space with one open end flexibly enough to provide heat along with the body curve; and a portable power supply portion, separately arranged from the case, supplying power to the surface heater for generating heat.

However, the warming device according to Prior art No. 2 requires a surface heater generating heat by carbon applied on PET film as high resistance material, or a surface heater generating heat by fine ceramic particle and conductive carbon particle evenly applied on fiber fabric. Such surface heaters require 7-10 minutes for charging to reach to a maximum heating temperature, whereas the temperature dwelling time is as short as 1-2 hours. Consequently, the device according to Prior art No. 2 is inconvenient to use as well as requires high power consumption when it is used for long hours at outdoor activities during the change of seasons or in the cold weather because it requires a power supply portion such as a portable massive rechargeable battery, too heavy for the user to carry with.

### DISCLOSURE OF INVENTION

### Technical Problem

The present invention is designed to resolve the above mentioned issues by providing a portable auxiliary heating device which includes a surface heater, excellent in heating rate and heat retention, lasting for long hours on a single charging, and having excellent reliability and stability.

Additionally, the present invention is to provide a portable auxiliary heating device which is light in weight and thus good for activity.

### Technical Solution

To achieve the above mentioned effects, the portable auxiliary heating device according to some embodiments of the invention comprises a base substrate; electrodes formed on both end portions of a top surface of the base substrate; an external power connection part connected to electrode lines which are connected to the electrodes; a heating layer stacked on the base substrate and generating heat by external power applied through the electrodes; and an electrical insulation layer stacked on the heating layer, wherein the heating layer is made from a metallic oxide material.

A heating layer is made from any one selected from the group consisting of ITO (Indium Tin Oxide), IZO (Indium Zinc Oxide), ZnO (zinc oxide), SnO2 (tin oxide), ATO (antimony-doped tin oxide), AZO (Al-doped zinc oxide), GZO (gallium-doped zinc oxide), TiO2, FTO (fluorine-doped tin oxide), and a combination thereof.

The base substrate is made from any one selected from the group consisting of Silica glass, Quartz glass, Poly-imid film, Glass-fiber sheet, ceramic substrate, SUS sheet plate, and a combination thereof. The electrode is made from Ag—Pd alloy with 7:3 for argentum (Ag) to palladium (Pd) weight ratio, molybdenum (Mo), tungsten (W), and platinum (Pt).

The portable auxiliary heating device, according to some embodiments of the invention, may further comprise a case protecting a surface heater which includes a base substrate, electrodes, a heating layer, and an electrical insulation layer; a flame resistant cloth covering the case; a satchel providing a space for the surface heater covered by the flame resistant cloth; and a combining material formed on the satchel.

The portable auxiliary heating device according to the present invention is classified into two types: for adult use or for child use, depending on the charging time for electric current to be applied to the electrodes, or the surface temperature of the device after completion of charge.

### Advantageous Effects

According to the above configuration, the portable auxiliary heating device of the present invention provides the effects as follows.

First, power consumption necessary for the charging of the surface heater can be decreased. By having external power applied to electrodes, charging the surface heater takes only 1-3 minutes to reach to a maximum heating temperature.

Second, long-hour heating is possible as the temperature of the surface heater falls gradually after the completion of charging.

Third, the heating efficiency is excellent as the heat is evenly generated through the entire surface of the surface heater.

Forth, the electrode has excellent reliability with little resistance change and with no fall-away on high heat because it is made from Ag—Pd alloy with 7:3 for argentum (Ag) to palladium (Pd) weight ratio, molybdenum (Mo), tungsten (W), and platinum (Pt).

Fifth, the safety accidents related to the surface heater such as burns or fire can be prevented by a flame resistant cloth and a temperature control portion arranged on the surface heater.

Sixth, the surface heater is designed to emit more than 90% of far-infrared radiation with 5-20 μm wavelength, which, penetrating through the thick skin and absorbed in the body, provides thermal effect by auto-thermal action, relieves fatigue, and promotes metabolism by activating cellular tissues.

Seventh, the auxiliary heating device, including a surface heater with a maximum heating temperature of 300-500° C. and using latent heat of a base substrate, is light in weight and good for activity, compared with conventional heating devices such as a heating jacket using water, or a device using ceramic case.

### BRIEF DESCRIPTION OF THE DRAWINGS

FIG. 1 is a diagram illustrating an exemplary view of the exterior of the portable auxiliary heating device according to the present invention.

FIG. 2 is a diagram illustrating an exemplary configuration of the portable auxiliary heating device according to the present invention.

FIG. 3 is a diagram illustrating an exemplary configuration of the surface heater used for the portable auxiliary heating device according to the present invention.

FIG. 4 is a graph presenting the relations of the temperature to the time measured in the charging test of the surface heater used for the portable auxiliary heating device according to the present invention.

### BEST MODE OF CARRYING OUT THE INVENTION

The present invention will be described more fully hereinafter with reference to the accompanying drawings, in which some embodiments of the invention are shown.

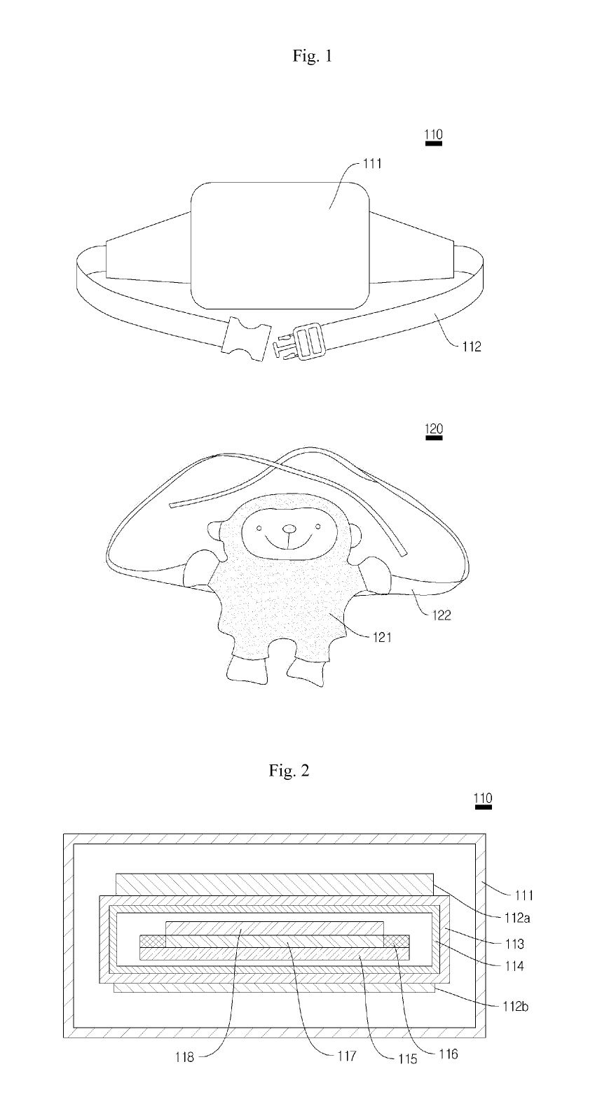

FIG. 1 is a diagram illustrating an exterior of the portable auxiliary heating device according to the present invention. The reference numeral 110 indicates a portable auxiliary heating device for adult and 120 does for child.

The portable auxiliary heating devices for adult (110) and for child (120) include, respectively, a satchel (111,121) holding surface heater, and a combining material (112, 122) arranged on the satchel (111, 121).

A satchel (111, 121) prevents a user's skin from getting burns by contacting directly to the surface heater on high heat. The satchel (111,121) may be manufactured in many different forms according to the user's personality and taste. For example, as shown by FIG. 1, the satchel (121) for the portable auxiliary heating device for child (120) may be manufactured in the form of animal such as a monkey, while the form is not limited thereto; the forms may vary including Pororo, sun, or heart. For another example, the satchel (121) may have a printed pattern of a butterfly, flower, or toy on its covering.

A combining material (112, 122), fixed on the satchel (111,121) or attachable thereto, makes the satchel (111, 121) to be worn on the user's body. The combining material (112,122) has a length adjuster to adjust according to the user's body size. The user can wear the portable auxiliary heating device according to the present invention on his/her abdomen, in the side, or on his/her back.

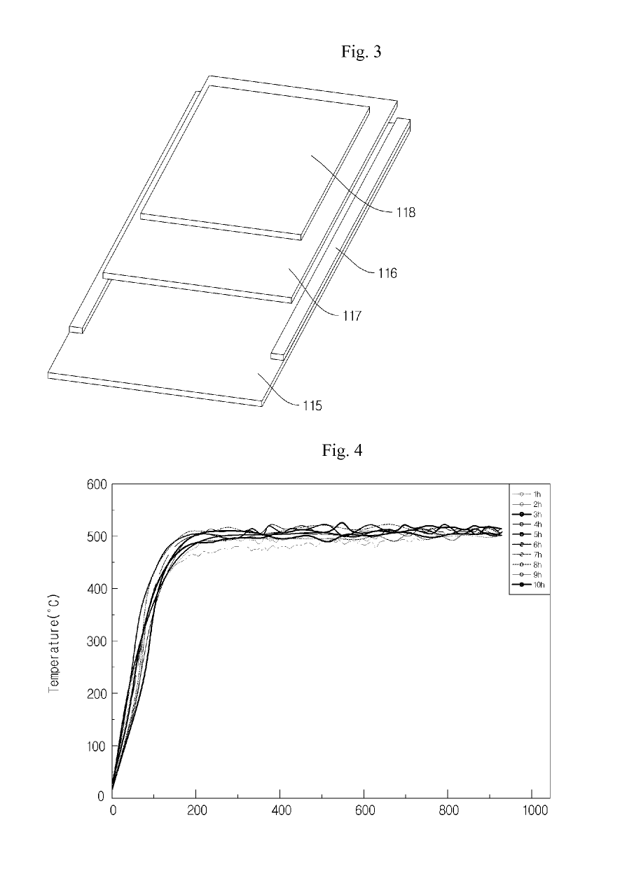

FIG. 2 is showing an exemplary configuration of the portable auxiliary heating device according to the present invention, and FIG. 3 is showing an exemplary configuration of the surface heater used for the portable auxiliary heating device according to the present invention. In FIG. 2 and FIG. 3, it is assumed herein the exemplary embodiments of the portable auxiliary heating device according to the present invention are designed for adult use.

The portable auxiliary heating device according to the present invention, as shown by FIG. 3, comprises a satchel (111), an heat insulating material (112a, 112b), a flame resistant cloth (113), a case (114), and a surface heater protected by the case (114).

The satchel (111) prevents the user's skin from getting burns by contacting directly to the surface heater on high heat. In addition, the satchel (111) can be manufactured in many different forms according to the user's personality and taste.

The heat insulating material (112a, 112b), arranged between the flame resistant cloth (113) and the satchel (111), is made from the material such as general heat insulating material, cotton, duck down, or wood shavings. The heat can be transferred by insulation obtained from cotton, duck down, and wood shavings and by insulation from the air. The heat insulating material (112a, 112b) has, for example, about 4-10 mm thickness.

The flame resistant cloth (113), a special cloth for preventing the flame from spreading, can prevent a spread of fire which may occur due to malfunction during the charging of the surface heater or after the completion of charging. The flame resistant cloth, for example, may be made from a special ModAcrylic flame resistant fabric.

The case (114), holding and protecting the surface heater, consists of attachable top and bottom cases. According to the exemplary embodiment, the case (114) is made of metal such as aluminum.

The surface heater protected by the case (114) includes a base substrate (115); an electrode (116); a heating layer (117); and an electrical insulation layer (118). The surface heater used for the portable auxiliary heating device according to the present invention gets heated by the external power applied thereto; thus, it is stable on high heat, generates heat evenly throughout the surface, and can be formed on the flexible film.

The base substrate may be made from one selected from the group consisting of Silica glass, Quartz glass, Poly-imid film, Glass-fiber sheet, ceramic substrate, and SUS sheet plate. Platinum (Pt) used to be considered as a material for the base substrate (115), however, the manufacturing cost increased as the cost of Platinum increased, and there was a stability issue regarding the coefficient of thermal expansion of Platinum. The heat retention time may differ according to the heat capacity of the base substrate (115). That is, the thicker the base substrate (115) is, the longer the heat lasts. It is desirable to adjust the thickness of the base substrate (115) with consideration for activity.

The electrode (116) has excellent reliability with little resistance change and with no fall-away on high heat because it is made from materials including Ag—Pd alloy with 7:3 for argentum (Ag) to palladium (Pd) weight ratio, molybdenum (Mo), tungsten (W), and platinum (Pt).

A heating layer (117), stacked on the base substrate (115), is made from a metallic oxide material to prevent the aging of the base substrate (115) and to enhance the adhesiveness to the base substrate (115). For example, the heating layer (117) is made from any one selected from the group consisting of ITO (Indium Tin Oxide), IZO (Indium Zinc Oxide), ZnO (zinc oxide), SnO2 (tin oxide), ATO (antimony-doped tin oxide), AZO (Al-doped zinc oxide), GZO (gallium-doped zinc oxide), TiO2, PTO (fluorine-doped tin oxide), and a combination thereof.

The heating layer (117) can be formed in a way that the metallic oxide paste, whose particle size is 70-100 μm and particle concentration is 20%, is applied to the base substrate (115) by means of spray coating or screen printing, and treated by heat on 200-400° C.

An electrical insulation layer (118) is made from a material preventing the heating layer (117) from corrosion, scratch, and from soil, and enhancing the durability thereof. The insulation layer (118), for example, may be made from a coating material such as Polysilazane, and formed by means of spray coating or screen printing.

Although not shown by FIG. 2 or FIG. 3, the portable auxiliary heating device according to the present invention may include an electrode cable connecting external power to the electrode (116). For example, the electrode cable may further include a temperature control portion, which may be formed with a thermostat and a temperature sensor (for example, a bimetal).

The heat transfer mechanism of the portable auxiliary heating device according to the present invention is as follows; the order of the heat transfer, starting from the surface heater→the air→the case (114)→the flame resistant cloth (113)→the heat insulating material (112a, 112b)→the satchel (111)→the user. The portable auxiliary heating device according to the present invention has the surface heater whose maximum heating temperature is 300-500° C., and uses the latent heat of the base substrate (115). The case (114) is arranged at about 5-10 mm distance from the surface heater; even though the temperature of the surface heater immediately goes up to above 400° C. due to the heat insulating material (112a, 112b) and the insulation property of air, the actual temperature gradually transferred to the user is only an initial temperature of 60-70° C.

FIG. 4 is a graph presenting the relations of the temperature to the time measured in the charging test of the surface heater used for the portable auxiliary heating device according to the present invention.

The charging test of the surface heather has been done for 10 times; the size of the tested surface heater was 100 mm width, 100 mm length, and 3 mm height, and the external power applied to the micro heater was 300 W 220V.

As shown by FIG. 4, the time necessary for the surface heater to complete a charging (which also means to reach to a maximum heating temperature) was only 1-3 minutes. Thus, the portable auxiliary heating device according to the present invention requires less power consumption due to a short charging time.

As a result of comparing the temperatures measured at the bottom, at the top, and at the center of the surface heater, the temperatures measured by position are almost the same. That is, the heating efficiency is excellent as the heat is generated evenly throughout the surface.

In the test report, published by Korea Far Infrared Applied Research and Evaluation Center affiliated with Korea Far Infrared Association, presenting the emissivity of the surface heater used for the portable auxiliary heating device according to the present invention, the radiation energy of the surface heater is 3.66×10² (W/m²-μm, 40° C.), and the emissivity of far-infrared radiation with the wavelength of 5-20 μm is above the 90%.

The far-infrared radiation, penetrating the thick skin and absorbed in the body, provides thermal effect by auto-thermal action, and relieves fatigue and promotes metabolism by activating cellular tissues.

It is to be understood that the invention is not limited to the disclosed embodiment, but on the contrary, is intended to cover various modification and the equivalent arrangements which can be implemented by the ordinary skilled in the art, within the spirit and the scope of the appended claims. Accordingly, the scope of the present disclosure shall be determined only according to the attached claims.

1. A portable auxiliary heating device, comprising:
a base substrate;
electrodes formed at both end portions of the base substrate;
an external power connection part connected to electrode lines which are connected to the electrodes;
a heating layer stacked on the base substrate and generating heat by external power applied through the electrodes; and
an electrical insulation layer stacked on the heating layer,
wherein the heating layer is made from a metallic oxide material.

2. The portable auxiliary heating device of claim 1,
wherein the metallic oxide material is made from any one selected from the group consisting of ITO (Indium Tin Oxide), IZO (Indium Zinc Oxide), ZnO (zinc oxide), SnO2 (tin oxide), ATO (antimony-doped tin oxide), AZO (Al-doped zinc oxide), GZO (gallium-doped zinc oxide), TiO2, FTO (fluorine-doped tin oxide), and a combination thereof.

3. The portable auxiliary heating device of claim 1,
wherein the heating layer emits more than 90% of far-infrared radiation with 5-20 μm wavelength.

4. The portable auxiliary heating device of claim 1,
wherein the charging time necessary for the heating layer to reach to a maximum heating temperature requires only 1-3 minutes due to external power applied to the electrodes.

5. The portable auxiliary heating device of claim 1,
wherein the base substrate is made from any one selected from the group consisting of Silica glass, Quartz glass, Poly-imid film, Glass-fiber sheet, ceramic substrate, SUS sheet plate, and a combination thereof.

6. The portable auxiliary heating device of claim 1,
wherein the electrode is made from the materials including Ag—Pd alloy with 7:3 for argentum (Ag) to palladium (Pd) weight ratio, molybdenum (Mo), tungsten (W), and platinum (Pt).

7. The portable auxiliary heating device of claim 1, further comprising:
a case protecting a surface heater which includes the base substrate, the electrode, the heating layer, and the electrical insulation layer;
a flame resistant cloth covering the case;
a satchel providing a space for the surface heater protected by the flame resistant cloth; and
a combining material arranged on the satchel.

8. The portable auxiliary heating device of claim 7, further comprising:
a heat insulating material formed between the flame resistant cloth and the satchel.

9. The portable auxiliary heating device of claim 1,
wherein a temperature control portion is arranged on the electrode line.

10. The portable auxiliary heating device of claim 9,
classified into two types: for adult and for child use, depending on the charging time for applying electric current to the electrode, or the surface temperature after the completion of charging.
